(19) United States
(12) Patent Application Publication
(10) Pub. No.: US 2019/0072027 A1
(43) Pub. Date: Mar. 7, 2019

(54) CELL WHEEL

(71) Applicant: GF Casting Solutions AG, Schaffhausen (CH)

(72) Inventor: Dirk Weid, Schaffhausen (CH)

(21) Appl. No.: 16/120,325

(22) Filed: Sep. 3, 2018

(30) Foreign Application Priority Data
Sep. 4, 2017 (EP) 17 189 222.7

(51) Int. Cl. F02B 33/42; F04F 13/00

(52) U.S. Cl. CPC F02B 33/42; F04F 13/00

(57) ABSTRACT

A cell wheel of a pressure wave supercharger includes an outer sleeve, an inner sleeve, and an axle having a center line around which the inner sleeve and the outer sleeve are coaxially arranged. The cell wheel further includes blades that extend around the outside diameter of the inner sleeve and that are arranged between the inner sleeve and the outer sleeve and end discs arranged at ends in the inner sleeve and connected rigidly to the axle in a circumferential direction. The end discs are designed as separate parts and are connected rigidly to the inner sleeve in the circumferential direction. The end discs and the inner sleeve are configured to be moved relative to one another in a radial direction.

### CROSS REFERENCE TO RELATED APPLICATIONS

This application claims benefit to European Patent Application No. EP 17 189 222.7, filed Sep. 4, 2017, which is incorporated by reference herein.

### FIELD

The invention relates to a cell wheel of a pressure wave supercharger comprising an outer sleeve, an inner sleeve, an axle, wherein the axle has a center line, around which the inner and outer sleeves are arranged coaxially, blades, wherein the blades extend around the outside diameter of the inner sleeve and are arranged between the inner and outer sleeves, and end discs, wherein the end discs are arranged at the ends of the inner sleeve and are connected rigidly to the axle in the circumferential direction.

### BACKGROUND

In developing new vehicle engines, it is important nowadays to reduce fuel consumption and exhaust emissions without, however, having to accept power losses. The aim is to keep the power of the engine high, despite a reduced swept volume, by pressure-charging the engine by means of a pressure wave supercharger.

The rotor of a pressure wave supercharger is designed as a cell wheel, which is surrounded by a housing.

Owing to the fact that hot exhaust gases and fresh air flow into the cell wheel, the cell wheel has different temperatures at different locations, and the cell wheel is subject to large temperature changes with respect to time during operation, between the time of engine starting and the operational state.

DE 1 503 616 discloses a pressure exchanger having a cell wheel, wherein the cell wheel is connected in a fixed manner to two bearing journals. This entails the disadvantage that the inner ring and the outer ring cannot expand radially when there is an increase in temperature since the rings are connected in a fixed manner to the bearing journals, or the inner ring is formed integrally with the outer ring. This leads to stresses and deformations of the cell wheel in the case of unequal heating and cooling.

### SUMMARY

In an embodiment, the present invention provides a cell wheel of a pressure wave supercharger. The cell wheel includes an outer sleeve, an inner sleeve, and an axle having a center line around which the inner sleeve and the outer sleeve are coaxially arranged. The cell wheel further includes blades that extend around the outside diameter of the inner sleeve and that are arranged between the inner sleeve and the outer sleeve and end discs arranged at ends in the inner sleeve and connected rigidly to the axle in a circumferential direction. The end discs are designed as separate parts and are connected rigidly to the inner sleeve in the circumferential direction. The end discs and the inner sleeve are configured to be moved relative to one another in a radial direction.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a longitudinal section through a cell wheel according to an embodiment of the invention; and

FIG. 2 shows a plan view of a cell wheel according to an embodiment of the invention.

### DETAILED DESCRIPTION

Embodiments of the invention provide a cell wheel in which reduced stresses or deformations occur in the cell wheel owing to irregular temperature changes.

According to embodiments of the invention, the end discs are designed as separate parts and are connected rigidly to the inner sleeve in the circumferential direction, wherein the end discs and the inner sleeve can be moved relative to one another in the radial direction.

The cell wheel has an outer sleeve which is arranged coaxially with the inner sleeve and with the axle and the corresponding center line. End discs, preferably two end discs, are used to secure the inner sleeve on the axle. These discs are arranged at the ends on the inner circumference of the inner sleeve. The end discs are preferably arranged positively on the axle, wherein they are axially movable, preferably against stops in the inner sleeve. Arranged between the outside diameter of the inner sleeve and the inside diameter of the outer sleeve are blades, which divide the cell wheel into cells. The blades are preferably embodied as separate parts, which are mounted between the two diameters of the sleeves by insertion, welding, adhesive bonding or in some other way. The blades are preferably mounted at irregular intervals but, as another possibility, at regular intervals around the outside diameter of the inner sleeve or the inside diameter of the outer sleeve. The blades preferably extend radially, wherein they can have a straight profile or a swept or bent profile.

The end discs are connected rigidly to the axle in the circumferential direction, preferably by means of positive engagement.

The end discs are designed as separate parts and are connected rigidly to the inner sleeve in the circumferential direction, wherein the end discs and the inner sleeve can be moved relative to one another in the radial direction. That is to say that, if there is nonuniform heating, which is very much the case with a cell wheel, the inner sleeve has the ability to expand radially more than the end discs, or the inside diameter of the cell wheel can increase without necessarily involving the outside diameter of the end discs. As a result, the parts move away from one another and towards one another again when the parts cool. As a result, the parts can change dimensions independently of one another. Of course, some other movement of the parts relative to one another is also conceivable.

An advantageous embodiment of the end discs consists in connecting end discs positively to the inner sleeve in the circumferential direction, which, during the rotary movements of the cell wheel or the axle, ensures optimum or frictionless transmission of the rotary motion from the axle, via the end discs, to the inner sleeve and thus also to the blades and the outer sleeve, which are preferably likewise connected rigidly to the inner sleeve in the circumferential direction, wherein, as mentioned above, the connection between the inner sleeve, the blades and the outer sleeve can be configured with different types of connection, whether by welding, insertion, adhesive bonding or some other type of connection, and an integral configuration of the outer sleeve, the inner sleeve and the blades is also conceivable.

The end discs and the inner sleeve preferably have toothing, which engage in one another. By means of this toothing, transmission of the rotary motion of the axle to the inner sleeve with minimum or zero backlash is possible.

It is advantageous if the tooth flanks of the end discs and of the inner sleeve extend radially or are aligned radially. That is to say that the tooth flanks are aligned perpendicularly to the center line, and the surfaces of the tooth flanks of the end discs and of the inner sleeve preferably rest on one another in a plane-parallel manner.

The relative motion between the end discs and the inner sleeve is preferably guided by the tooth flanks. That is to say that, when there is an expansion of the inner sleeve, said sleeve moves radially relative to the end discs since this movement is guided by means of the tooth flanks.

According to a preferred embodiment, the tip circle diameter of the end discs is smaller than the root circle diameter of the inner sleeve, and the root circle diameter of the end discs is smaller than the tip circle diameter of the inner sleeve, preferably smaller by an amount such that there is a significant clearance, specifically preferably 0.5-10 mm, between the tip circle diameter of the end discs and the root circle diameter of the inner sleeve, as well as between the root circle diameter of the end discs and the tip circle diameter of the inner sleeve. This also allows greater expansion of the end discs in comparison with the expansion of the inner sleeve without the end discs being hindered by the inner sleeve.

It is advantageous if the end discs and the inner sleeve have at least two teeth in order to transmit the rotary motion.

In order nevertheless to obtain as uniform as possible expansion of the end discs and of the inner sleeve, it is advantageous if the inner sleeve comprises the same material as the end discs and thus has the same expansion coefficient. End discs which have a lower thermal expansion coefficient than the inner sleeve are also conceivable.

According to embodiments of the invention, the blades are aligned radially between the inner sleeve and the outer sleeve. Of course, the blades do not have to extend in a straight line but can also be bent or curved. Moreover, it is advantageous if the blades are designed as separate parts and can be mounted or secured between the inner sleeve and the outer sleeve.

In a preferred embodiment, the end discs are arranged on the axle by means of positive engagement, preferably by means of a parallel key joint, allowing frictionless transmission of the rotary motion and nevertheless axial mobility.

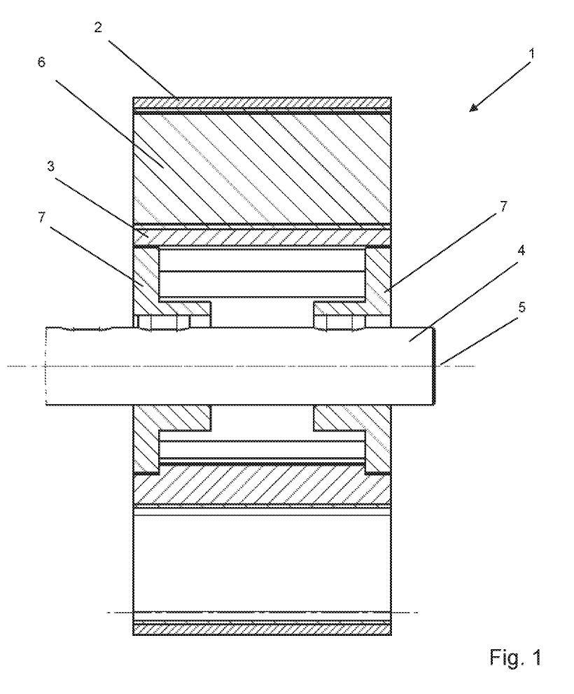

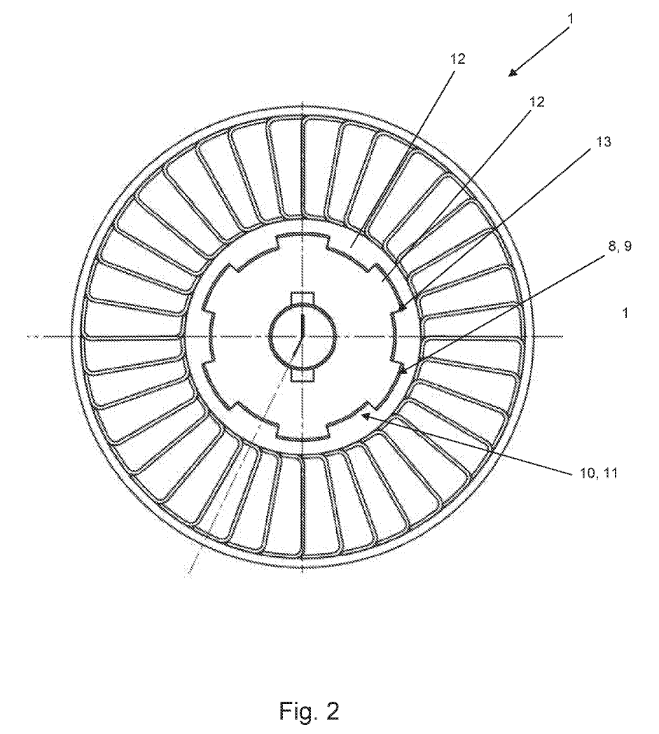

FIG. 1 shows the longitudinal section of a cell wheel 1 according to the invention. The outer sleeve 2 and the inner sleeve 3 extend coaxially with the center line 5 of the axle 4 by means of which the cell wheel 1 is driven, e.g. in a pressure wave supercharger. Blades 6 extend in a radial direction between the inner sleeve 3 and the outer sleeve 2, dividing the cell wheel 1 into cells, this being readily visible from FIG. 2. In the embodiment depicted, the blades 6 are shown as bent at their ends, but straight blades could, of course, also be used. The blades could also have a bent or curved shape. The blades 6 are separately formed parts, which are arranged between the outside diameter of the inner sleeve 3 and the inside diameter of the outer sleeve 2. The fastening of the blades 6 must be adapted to the requirements, i.e. the blades 6 can be mounted between the sleeves by insertion, welding, adhesive bonding or in some other way, but can also be produced as a coherent part together with the sleeves.

End discs 7 are arranged at the ends of the inner sleeve 3. The end discs 7 are preferably arranged positively on the axle 4, such that they are secured rigidly on the axle 4 in the circumferential direction but can be moved in the axial direction. The end discs 7 are separately formed parts, which are connected to the inner sleeve 3 by means of positive engagement, preferably in such a way that the positive engagement comes to bear in the circumferential direction and the inner sleeve 3 and the other parts of the cell wheel 1 corotate without backlash as the axle 4 is driven.

The end discs 7 and the inner sleeve 3 are arranged in such a way as to be movable relative to one another in the radial direction. This gives the parts the possibility of expanding or contracting to different extents due to the different temperatures with respect to space and time prevailing, for example, in a pressure wave supercharger, without being hindered by other parts and consequently without being deformed. In the embodiment illustrated, this is made possible by teeth 12 on the end discs 7 and in the inner sleeve 3. The toothings 12 on the end discs 7 engage in the toothing 12 on the inner sleeve 3. In the embodiment depicted, the end discs 7 and the inner sleeve have six teeth 12, but a different number of teeth for the joint is, of course, also possible. The toothing 12 on the end discs 7 and that on the inner sleeve 3 rest against one another at the tooth flanks 13 and there is clearance between the tip circle of the end disc 8 and the root circle of the inner sleeve 9 and between the root circle of the end disc 10 and the tip circle of the inner sleeve 11. This clearance ensures that the parts have the possibility of movement decoupled from the other parts, i.e. they can move or expand and contract independently of one another. The tooth flanks 13 serve for guided movement during a change in the dimensions due to the temperature changes which occur.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

1 cell wheel
2 outer sleeve
3 inner sleeve
4 axle
5 center line
6 blades
7 end disc
8 tip circle of end disc
9 root circle of inner sleeve
10 root circle of end disc
11 tip circle of inner sleeve
12 tooth/toothing
13 tooth flanks

1. A cell wheel of a pressure wave supercharger, comprising:
an outer sleeve;
an inner sleeve;
an axle having a center line around which the inner sleeve and the outer sleeve are coaxially arranged;
blades that extend around the outside diameter of the inner sleeve and that are arranged between the inner sleeve and the outer sleeve; and
end discs arranged at ends in the inner sleeve and connected rigidly to the axle in a circumferential direction,
wherein the end discs are designed as separate parts and are connected rigidly to the inner sleeve in the circumferential direction, and
wherein the end discs and the inner sleeve are configured to be moved relative to one another in a radial direction.

2. The cell wheel according to claim 1, wherein the end discs are connected positively to the inner sleeve in the circumferential direction.

3. The cell wheel according to claim 1, wherein the end discs and the inner sleeve have toothing, which engage in one another.

4. The cell wheel according to claim 1, wherein tooth flanks of the end discs and of the inner sleeve extend radially or are aligned radially.

5. The cell wheel according to claim 4, wherein the relative movement between the end discs and the inner sleeve is guided by the tooth flanks.

6. The cell wheel according to claim 1, wherein a tip circle diameter of the end discs is smaller than a root circle diameter of the inner sleeve, and wherein the root circle diameter of the end discs is smaller than the tip circle diameter of the inner sleeve.

7. The cell wheel according to claim 1, wherein the end discs and the inner sleeve have at least two teeth.

8. The cell wheel according to claim 1, wherein the inner sleeve comprises a same material as the end discs.

9. The cell wheel according to claim 1, wherein the blades are aligned radially.

10. The cell wheel according to claim 1, wherein the end discs are arranged on the axle by way of positive engagement.

11. The cell wheel according to claim 1, wherein the end discs are arranged in an axially movable manner.

12. The cell wheel according to claim 1, wherein the blades are designed as separate parts.

13. The cell wheel according to claim 6, wherein the root circle diameter of the end discs is smaller than the tip circle diameter of the inner sleeve by an amount such that there is a clearance of between 0.5 and 10 mm.

14. The cell wheel according to claim 10, wherein the end discs are arranged on the axle by way of a parallel key joint.
